(19) United States
(12) Patent Application Publication
(10) Pub. No.: US 2023/0309543 A1
(43) Pub. Date: Oct. 5, 2023

(54) TRACKED VEHICLE AND SYSTEM FOR SPRAYING

(71) Applicant: Milton Ford Knight, Perrysburg, OH (US)

(72) Inventor: Milton Ford Knight, Perrysburg, OH (US)

(21) Appl. No.: 18/131,050

(22) Filed: Apr. 5, 2023

Related U.S. Application Data
(60) Provisional application No. 63/327,379, filed on Apr. 5, 2022.

(51) Int. Cl. A01M 7/00

(52) U.S. Cl. CPC A01M 7/0092; A01M 7/0042; A01M 7/0085

(57) ABSTRACT

A tracked vehicle for spraying, a mixing platform or both. The tracked vehicle comprises an engine that powers both the propulsion of the tracked vehicle and the spraying of slurry. A mixing platform may be employed with the tracked vehicle and provides a blending tank for mixing ingredients to form a slurry for used by the tracked vehicle.

### CROSS REFERENCE TO RELATED APPLICATIONS

The present application claims the benefit of U.S. provisional patent application Ser. No. 63/327,379, filed Apr. 5, 2022, the contents of which are incorporated herein by reference.

### BACKGROUND OF THE INVENTION

This invention relates to a tracked vehicle used for spraying slurry materials onto the ground. The invention also relates to a mixing platform that allows for loading, filling, and mixing materials to be sprayed out of the tracked vehicle, and a transfer system to move the mixed materials from the mixing platform to a tank of the tracked vehicle.

Hydroseeding and hydromulching are planting processes wherein a slurry of ingredients (typically including water, seed, fertilizer, tackifiers, or other chemistry with a GRS designation, fiber mulch, and a colorant dye) is sprayed onto an area of ground that is desired to be planted with grass or some other form of vegetation. Hydroseeding and hydromulching are often used as an alternative to hand-sowing or mechanically spreading dry grass seed on the soil, and then covering the seed with blown straw. In many instances, hydroseeding and hydromulching are more effective than traditional seeding and more economical than conventional sod, producing relatively quick grass growth and high germination rates. Erosion control techniques involve controlling the erosion of soil on sloped areas or sites by spraying a form of liquid on the soil that gets the soil to gel together, ultimately acting as a seal on the surface. Erosion control materials allow rain to run off without carrying part of the soil with it. In many instances, hydroseeding and hydromulching are more effective than traditional seeding and odor control sealants, which involve the application of film-producing chemistry with chemicals and other polymers on the surface of soil, where the objective is to limit the intrusion of rain and storm water flows. The film can either soak into the surface or create an impermeable surface once the material is dry. The film-forming aspect restricts the escaping of odor molecules that are released from the surface that has been coated. Alternative Daily Cover (ADC) materials are used in the operation of landfills. For these ground spraying operations, then, one or more vehicles are typically employed to apply the material to the ground.

The application of one form of slurry-based ADCs uses a standard hydroseeder or hydromulcher towed behind either a farm tractor or other form of powered vehicle. Other typical hydroseeders, hydromulchers and other slurry sprayer systems employ add-on skid-mounted sprayer units mounted on a rear deck of a tracked vehicle. In the conventional tracked vehicles, the add-on skid-mounted sprayer units include an engine that is separate from the engine that drives the tracked vehicle. The engine on the add-on skid-mounted sprayer unit either mechanically or hydraulically powers a slurry mixing auger and a pump. Such conventional tracked vehicles with add-on skid-mounted sprayer units, then, require both a first person to operate the tracked vehicle, and a second person to stand on the add-on skid-mounted sprayer unit (typically at an elevated position relative thereto) and manually operate a spray cannon in a back-and forth or up-and-down manner to apply the material to the ground. The operation of the tracked vehicle with the add-on skid-mounted sprayer unit also requires down time (or slack time) while the tracked vehicle hydroseeding or hydromulching tank is loaded with water, chemicals, and/or cellulose materials and then mechanically blended with the auger. Such down time for loading also requires the lifting of bags of cellulose and chemicals up onto the hydroseeding or hydromulching loading deck, and a forklift driver and another person to offload the bags that will be mixed in the tank onto the deck of the add-on skid-mounted sprayer unit.

Accordingly, it is desirable to provide a system that operates to apply a spray-on ground cover while minimizing the manpower and time needed to complete the operation.

### SUMMARY OF THE INVENTION

According to an aspect, an embodiment provides a tracked vehicle and system for spraying comprising: a tank configured to hold a slurry; tracks configured to propel the tracked vehicle; at least one spray nozzle configured to direct the slurry therethrough; a spray pump system configured to selectively draw the slurry from the tank and direct the slurry through the at least one spray nozzle; and an engine that provides power to both the tracks to propel the tracked vehicle and to the spray pump system to selectively draw the slurry from the tank and direct the slurry through the at least one spray nozzle.

According to an aspect, an embodiment provides a tracked vehicle having a tank, pump, valves and spray nozzles that includes a single engine that both propels the tracked vehicle and sprays the slurry of material (i.e., does not have separate engines to propel the tracked vehicle and to spray the slurry of material). The tracked vehicle can be used for spraying hydromulch or hydroseed, erosion control, dust control, odor control sealant, chemical, and other water-based slurry materials that serve as an alternative daily cover for solid or hazardous waste.

According to an aspect, an embodiment provides a tracked vehicle having a tank, pump, valves, and spray nozzles that does not require multiple persons to operate the system in order to move the tracked vehicle, to spray material on the ground, and load the tank on the back of the tracked vehicle.

According to an aspect, an embodiment provides to a combination of the tracked vehicle with a mixing platform to achieve improvements in productivity. The mixing platform allows a single person to load, fill, and mix the chemistry, additives, and other materials to be sprayed out of the tank on the tracked vehicle, a transfer system to move the mixed slurry of material from the mixing platform to a tank on the tracked vehicle. The tracked vehicle may also assist in the mixing of the slurry material from a tank on the mixing platform.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic, perspective view of a left side of a tracked vehicle connected to a mixing platform.

FIG. 2 is a schematic, perspective view of a right side of the tracked vehicle connected to the mixing platform.

FIG. 3 is a schematic, perspective view of a tank for the tracked vehicle.

FIG. 4 is a schematic, perspective view of a nozzle system for the tracked vehicle.

FIG. 5 is a schematic, perspective view of a portion of the mixing platform, with ingredients loaded thereon.

FIG. 6 is a schematic, elevation view of a portion of the mixing platform.

FIG. 7 is a schematic, top view of a portion of the mixing platform of FIG. 6.

FIG. 8 is a schematic, elevation view of a pallet lift of the mixing platform.

FIG. 9 is a schematic, elevation view of a portion of the mixing platform according to another embodiment.

FIG. 10 is a schematic, top view of a portion of the mixing platform of FIG. 9.

FIG. 11 is a schematic, elevation view of a portion of the mixing platform according to another embodiment.

### DETAILED DESCRIPTION OF THE PREFERRED EMBODIMENT

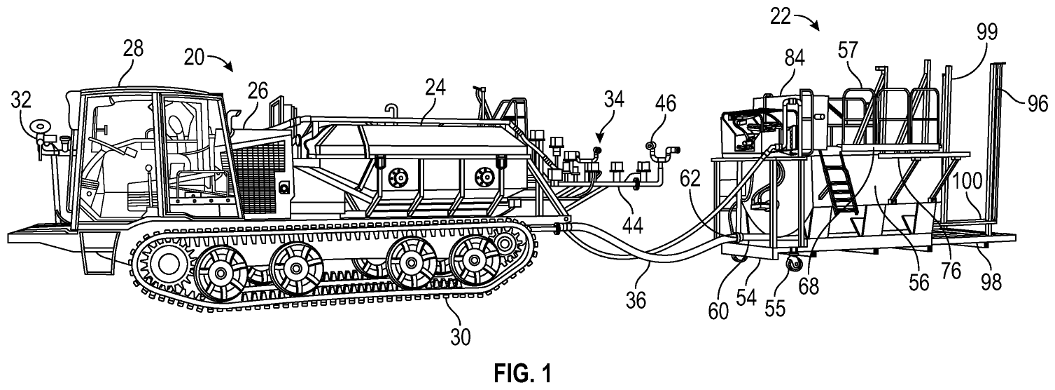

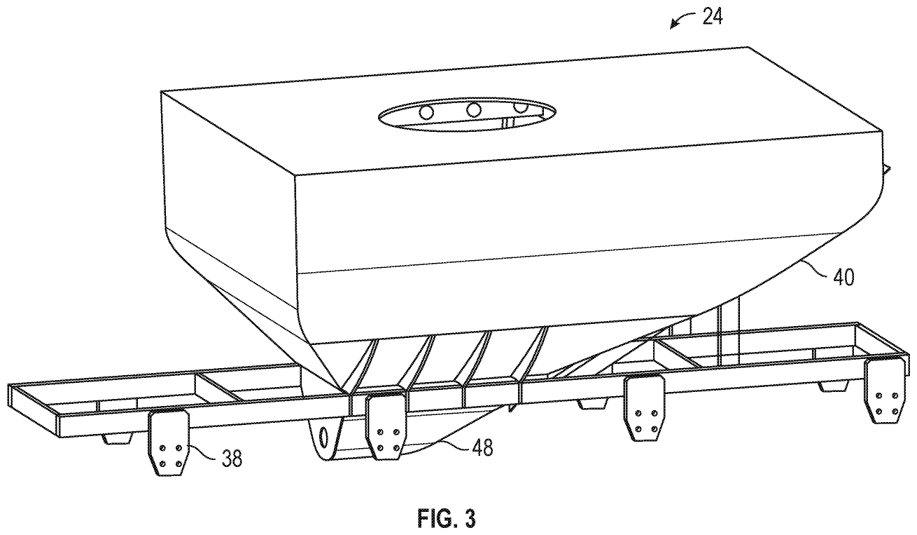

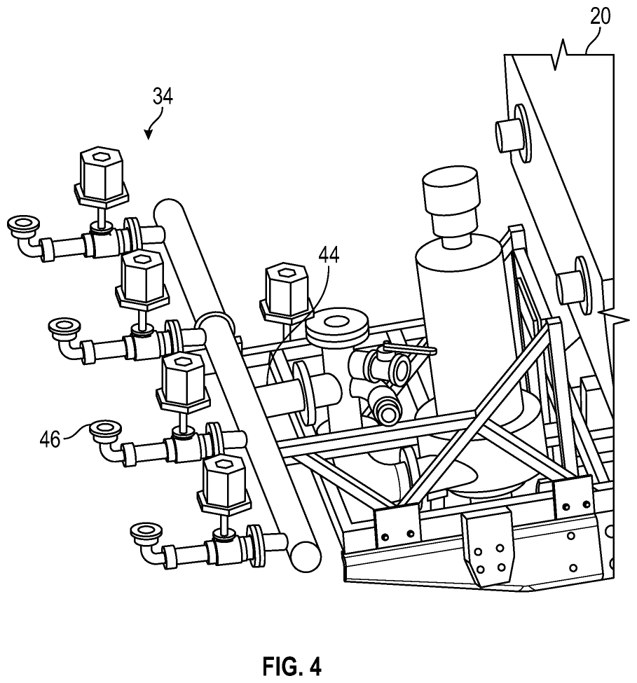

Referring to the example illustrated in FIGS. 1-4, a tracked vehicle 20 and a mixing platform 22 are illustrated. The tracked vehicle 20 comprises a tank 24, a drive engine 26, a cab 28, tracks 30, a front spray assembly (e.g., front mounted cannon) 32, a nozzle system (e.g., rear mounted spray bar) 34 and transfer hoses 36. The tank 24 may have mounts 38 to secure it to the tracked vehicle 20 and sloped sides 40 to cause the slurry to flow down to an outlet area (e.g., a sump) 42 where the slurry may be selectively directed toward the front spray assembly 32 and the nozzle system 34. The sloped sides 40 allow the slurry to flow to the outlet area 42 even when the tracked vehicle 20 is traveling on a slope (e.g., up to thirty degrees) of a hill. The front spray assembly 32 and the nozzle system 34 selectively receive a slurry from the tank 24, which slurry can be sprayed on the ground. The outlet area 42 includes a spray pump system 48 that may employ a vortex centrifugal spray pump or some form of a positive displacement pump being either a progressing cavity pump or gear pump. The spray pump system 48 may utilize an auxiliary drive motor that is fitted to the drive engine 26 that incorporates an auxiliary motor with a variable speed drive. The use of a variable speed drive motor allows the one drive motor to power a centrifugal spray pump at differing speeds, which allows the pushing of lower viscosity slurry through either a single front spray assembly 32 or multiple nozzles 46 on the nozzle system 34, or for pushing clean water through nozzle orifices for cleaning purposes; or a positive displacement pump that can suck and push thicker viscosity slurry, moving such higher viscosity slurry through either a single nozzle of the front spray assembly 32 or multiple nozzles of the nozzle system 34.

The slurry may be, for example, hydromulch or hydroseed, erosion control, dust control, odor control sealant, chemical, and other water-based slurry materials that serve as an alternative daily cover for solid or hazardous waste. The front spray assembly 32 has controls (e.g., a joystick) in the cab 28 that allow a vehicle operator to pivot the front spray assembly 32 in order to direct where the slurry is sprayed on the ground. The nozzle system 34 may include pipes 44 for transporting the slurry from the tank 24 to one or more of the multiple nozzles 46. The nozzles 46 can each by angled so that the angle of application for each complements the others to provide a desired spray pattern; and the volume of flow through each nozzle 46 provides the desired spray pattern. A vehicle operator in the cab 28 can control which of the nozzles 46 are opened to eject the slurry therefrom. This control of the nozzles 46 allows for the vehicle operator to vary where and how much of the ground is covered by the slurry (e.g., to the right, to the left, centered, or widely disbursed spray of the slurry onto the ground).

Of note for the example illustrated in FIGS. 1-4, since the tracks 30 and the tank 24 are both part of the tracked vehicle 20, the drive engine 26 is configured to both drive the tracks 30 to move the tracked vehicle 20 and to power (e.g., via pumps) the spraying of the slurry through the front spray assembly 32 and the nozzle system 34. Accordingly, only one engine is employed for both vehicle propulsion and application of a slurry. The cab includes controls for the drive engine 26, the tracks 30, and the spray control/pumping of the slurry through the front spray assembly 32 and the nozzle system 34. Thus, one vehicle operator in the cab 28 (which can be heated and air conditioned) can both control the propulsion and steering of the tracked vehicle 20 as well as control when and in what direction a slurry is sprayed onto the ground at the same time. The tracked vehicle 20 includes electronic hardware, software and programable logic controls, which controls may, for example, control the speed of the pump based upon any or all of: the type of slurry that is being sprayed; what nozzles are being utilized; and through what the slurry is being pumped. The tracked vehicle 20 may also include a flush tank that is used to flush-out the tank 24 after application of the slurry is completed. The tracked vehicle 20 may also include an auger system operatively engaging the tank 24, allowing for mixing of ingredients of the slurry within the tank 24. In addition, or alternatively, the mixing platform 22 is employed for mixing together the ingredients of the slurry.

In the example illustrated in FIGS. 1-4, the transfer hoses 36 are releasably connectable to the mixing platform 22. The transfer hoses 36 allow for transfer of slurry from the mixing platform 22 to the tank 24 of the tracked vehicle 20. The tracked vehicle 20 may use the spray pump assembly 48 to suck the slurry through the transfer hoses 36 from the mixing platform 22, thus not needing an additional pump on the mixing platform 22. By having the tank 24 as part of the tracked vehicle 20, with releasable transfer hoses 36, the tracked vehicle 20 can receive slurry from the mixing platform 22 through the releasable transfer hoses 36, disconnect the transfer hoses 36 from the mixing platform 22, travel to the location where the slurry is to be applied (using the drive engine 26 and tracks 30), and activate one of the front spray assembly 32 and the nozzle system 34 to spray slurry on the ground (using the drive engine 26 to power the pumping of slurry from the tank 24), while leaving the mixing platform 22 in place. Additionally, while the tracked vehicle 20 is applying the slurry to the ground at a different location from the mixing platform 22, the mixing platform 22 may be employed to mix additional slurry so the slurry will be ready for transfer when the tank 24 of the tracked vehicle 20 is empty. This allows the mixing platform 22 to be located where it is more convenient to store ingredients, where there is easy access to water, which is added to the blending tank 56 to form the slurry, where there is easy access to power, and possibly being located in a heated facility.

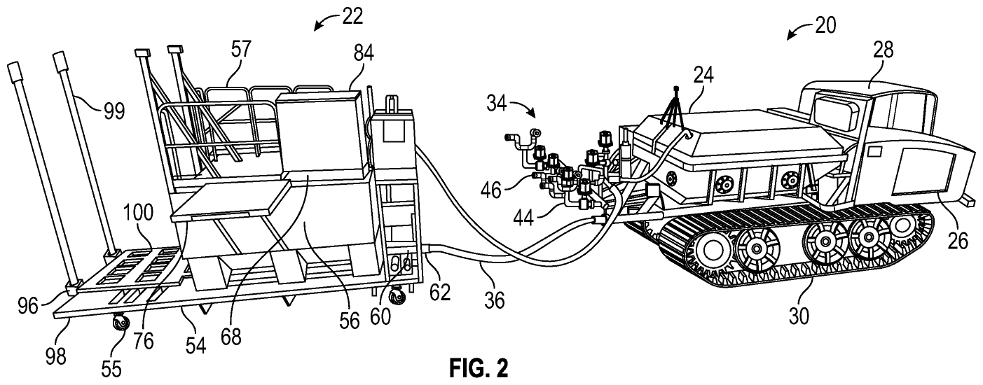

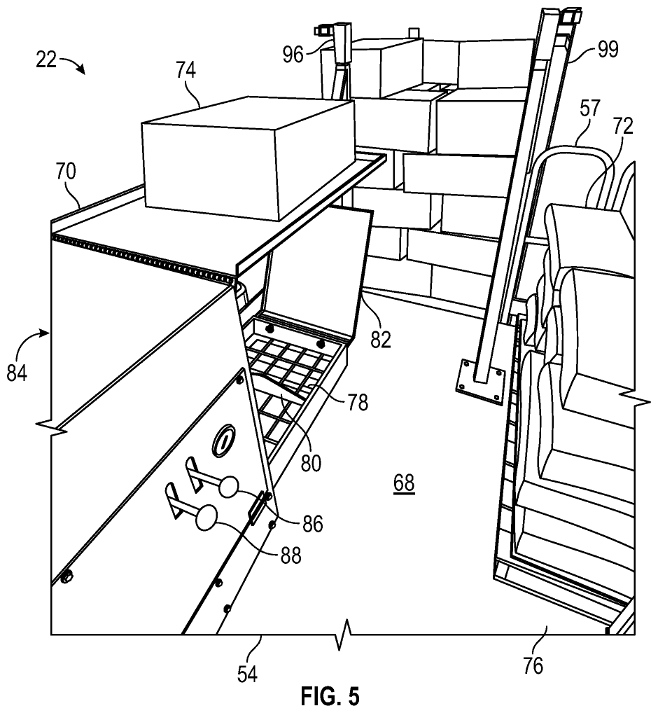

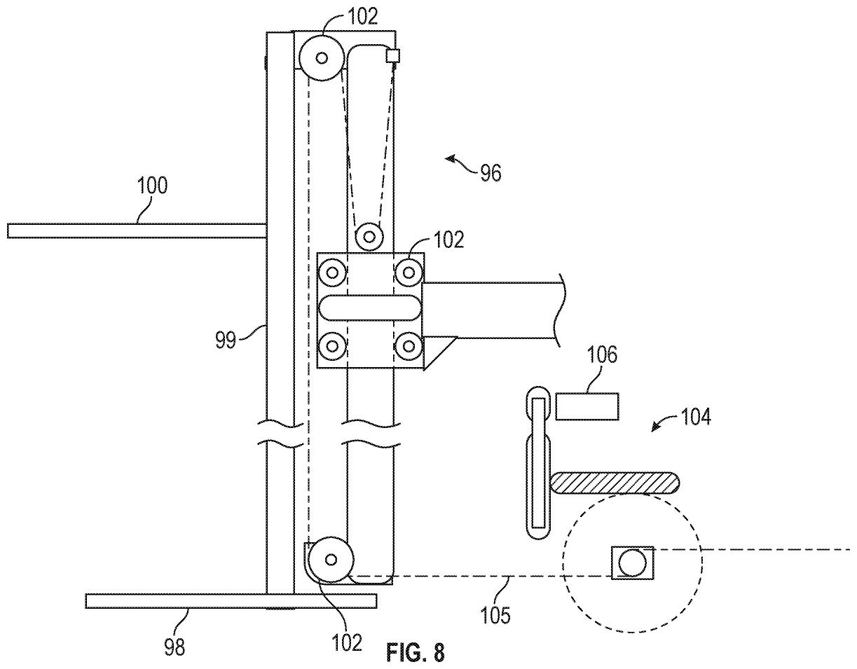

Referring now to the example illustrated in FIGS. 5-8, in view of FIGS. 1-2, the mixing platform 22 comprises a main frame 54, upon which various components are mounted that are employed for storing, moving, processing and mixing various ingredients that make up the particular slurry to be used. The mixing platform 22 comprises a blending tank 56 mounted on the main frame 54, augers 58 located in the blending tank 56 and rotatable to mix the ingredients of the slurry, a tank outlet 60 the receives the slurry from the blending tank 56, and a transfer hose connection 62, which may be a quick disconnect, that is connectable to one of the transfer hoses 36 for transferring slurry to the tracked vehicle 20. A power supply 64 operatively engages that augers 58 to turn them during mixing operations in the blending tank 56. The power supply may be, for example, a diesel or gas engine (and fuel) or electric motor (and battery 66) that supplies power to a hydraulic system.

In the example illustrated in FIGS. 5-8, in view of FIGS. 1-2, the main frame 54 comprises decks 68 (e.g., generally horizontal surfaces) that an operator can stand on while conducting a mixing operation and can be employed for storage of ingredients to be mixed (e.g., bags of chemicals 72, bags of cellulose 74). Since the mixing platform 22 is separate from the tracked vehicle 20, the ingredients can be stored on the decks 68 for later use, rather than needing to be removed during spraying of the slurry. The main frame 54 includes wheels 55 to allow for moving of the mixing platform 22, and ladder/railings 57 to allow for easier operator movement around the mixing platform 22. Other portions of the main frame 54 may include structural members that are selectively held in a horizontal position or pivotable to a more vertical position when not in use. For example, a debagging tray 70 may be mounted on and selectively pivotable relative to the main frame 54 for supporting a bag of cellulose 74 thereon while packaging is removed from around the cellulose, a support shelf 76 may be mounted on a selectively pivotable relative to the main frame 54 for bags of chemicals 72 thereon.

In the example illustrated in FIGS. 5-8, in view of FIGS. 1-2, the mixing platform 22 comprises assemblies for providing ingredients into the blending tank 56. A hatch opening 78 opens into the blending tank 56, with a bag cutter 80 extending over a portion of the hatch opening 78 that cuts open bags of the bags of chemicals 72 to allow the chemicals to drop into the blending tank 56, and a hatch lid 82 is pivotable to selectively cover and expose the hatch opening 78. The mixing platform 22 also comprises a mulch grinder assembly 84 having an opening adjacent to the debagging tray 70, which allows mulch, after being de-bagged, to be slid into the mulch grinder assembly 84, and an opening into the blending tank 56, which allows the ground mulch to be received into the blending tank 56. Grinding the mulch allows it to wet more quickly when added to the water in the blending tank 56. Adjacent to the mulch grinder assembly 84 are an auger engagement lever 86, which is actuatable by an operator to activate/deactivate the augers 58, and mulch grinder engagement lever 88, which is actuatable by an operator to activate/deactivate the mulch grinder assembly 84. The mixing platform 22 also comprises a chemical dispensing tank 90 connected to a pipe 92 directing chemicals from the chemical dispensing tank 90 into the blending tank 24, with a valve 94 selectively allowing/blocking flow from the chemical dispensing tank 90 into the blending tank 56. Thus, the mixing platform 22 allows for a single operator to stand on one of the decks 68, easily and quickly reach for and move the ingredients (e.g., cellulose, chemicals) into position for adding to the blending tank 56, add the ingredients into the blending tank 56, and activate the augers 58 to blend the ingredients together.

In the example illustrated in FIGS. 5-8, in view of FIGS. 1-2, the mixing platform 22 comprises a pallet lift 96. The Pallet lift 96 comprises a base 98, with vertical supports 99 extending upward from the base 98, a generally horizontally oriented lift platform 100 supported by the vertical supports 99, rollers 102, a cable 105 cooperating with the rollers 102, and a drive assembly 104 operatively engaging the cable 105 and rollers 102 to selectively raise/lower the lift platform 100. The drive assembly 104 may include a hydraulic drive (or electric motor) 106 to power the pallet lift 96. The pallet lift 96 may be employed, for example, to lift a pallet of bags of cellulose 74 from near the ground to a height adjacent to the debagging tray 70. This allows a single operator to easily and quickly move bags of cellulose 74 into position to be de-bagged and moved into the mulch grinder assembly 84.

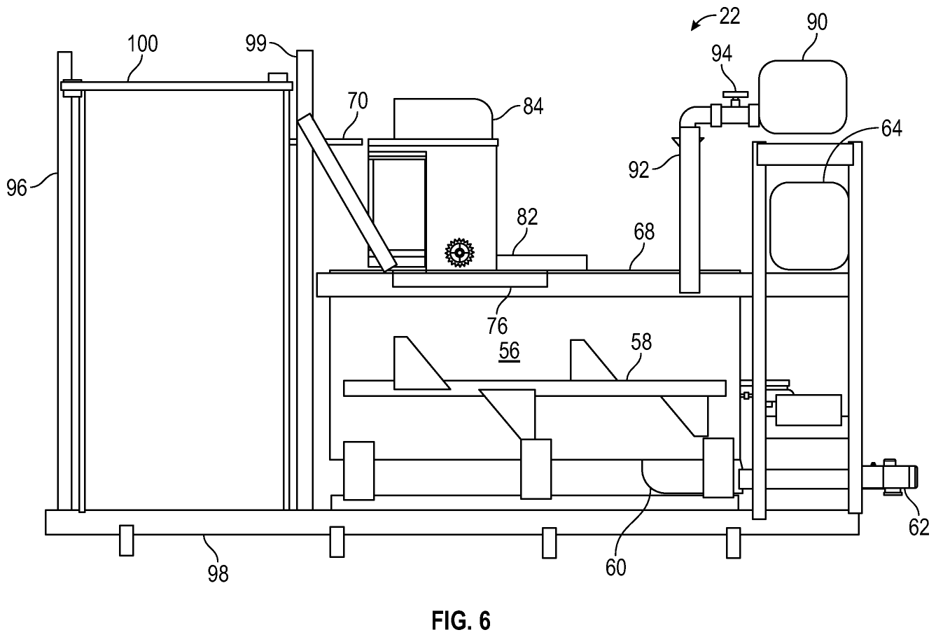

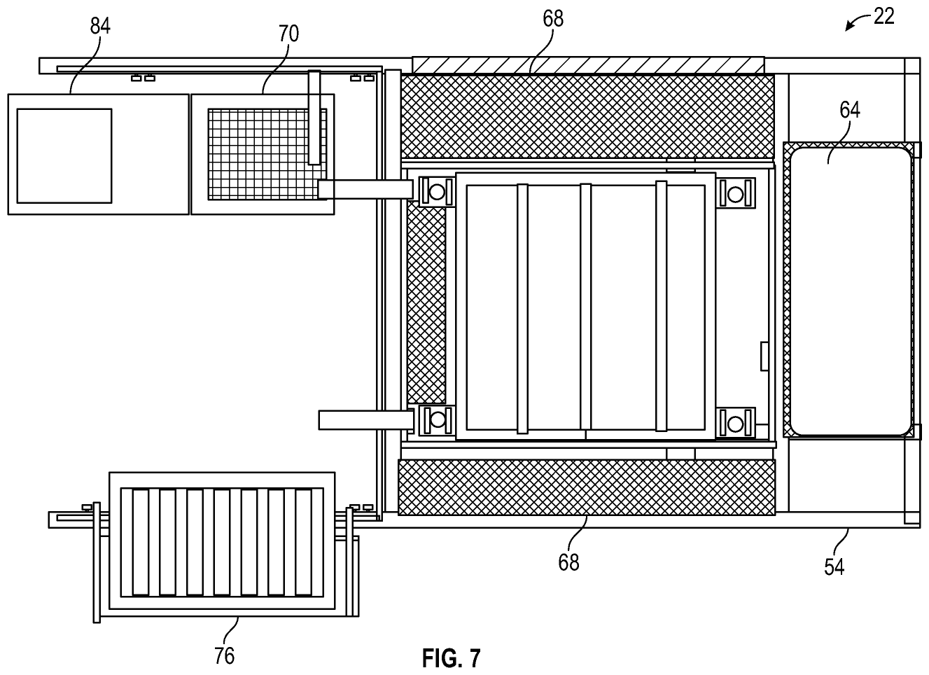

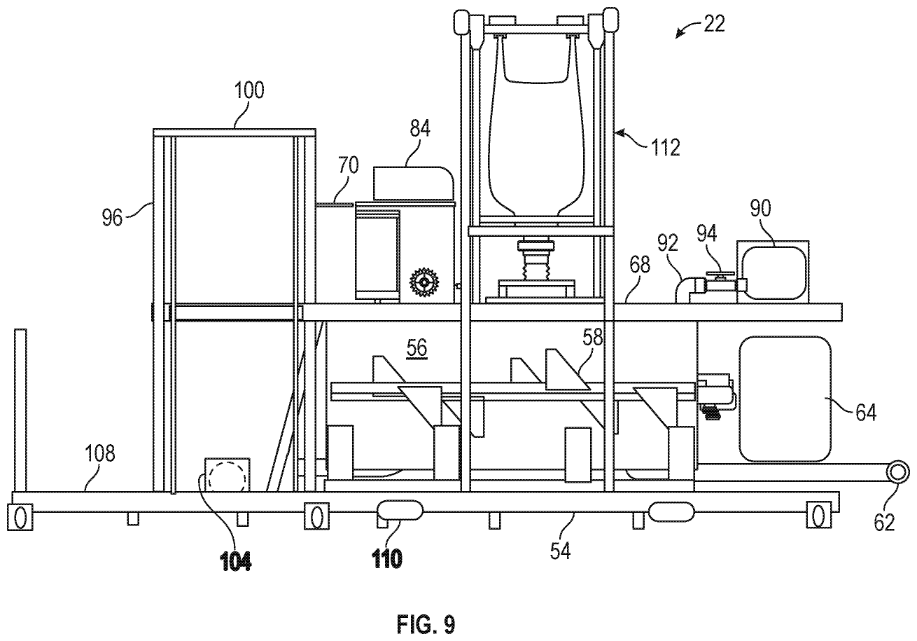

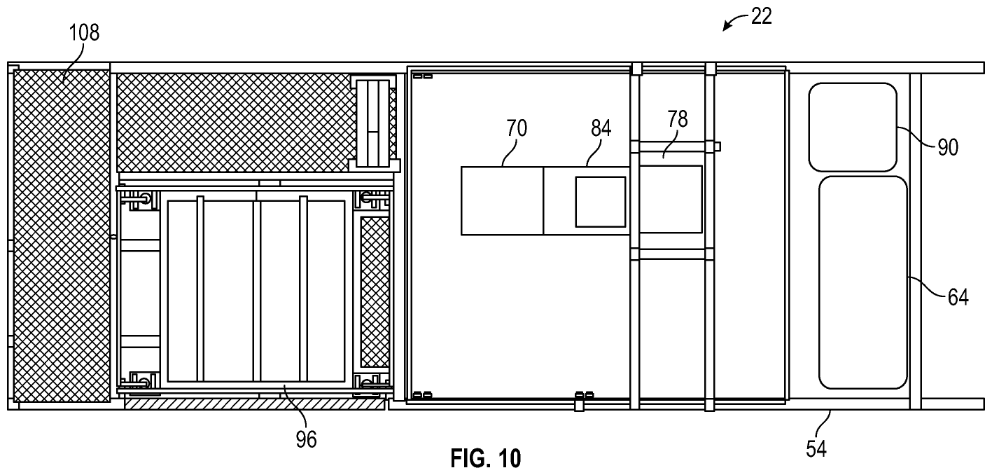

In the example illustrated in FIGS. 9 and 10, the mixing platform 22 is shown with a somewhat different configuration than the example in FIGS. 6 and 7. Since the two embodiments are similar, the same element numbers will be used for corresponding elements and the description of those elements will not be repeated. Only the changes in configurations between the two embodiments will be discussed. The power supply 64 is mounted lower on the main frame 54, closer to a drive for the augers 58. The main frame 54 extends out beyond the pallet lift 96, providing an additional deck 108 where additional ingredients (e.g., bags of chemicals) may be stored. The main frame 54 comprises forklift pockets 110, which may be employed to more easily allow a forklift to move the mixing platform 22 to a new location. The embodiment in FIGS. 6 and 7 may also include forklift pockets in its main frame rather than or in addition to the wheels. A tote sack dispenser assembly 112 is mounted on the main frame 54 above the hatch opening 78. The tote sack dispenser assembly 112 is loaded with one or more ingredients (e.g., chemicals from the bags of chemical 72). The tote sack dispenser assembly 112 can be actuated to selectively drop ingredients into the blending tank 56. The operation of the mixing platform 22 of FIGS. 9 and 10 is essentially the same as that for FIGS. 6 and 7 and so will not be discussed further herein.

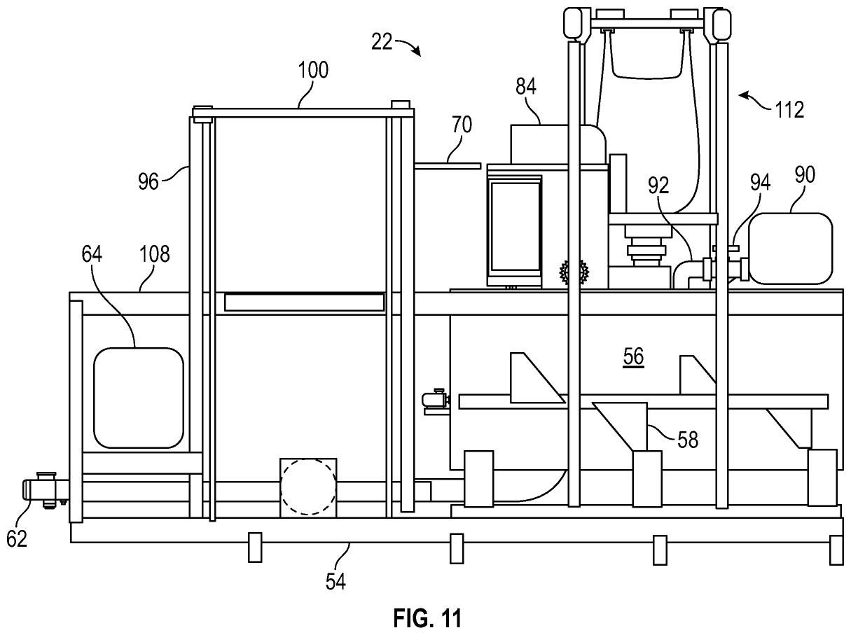

In the example illustrated in FIG. 11, the mixing platform 22 is shown with a somewhat different configuration than the example in FIGS. 6 and 7. Since the two embodiments are similar, the same element numbers will be used for corresponding elements and the description of those elements will not be repeated. Only the changes in configurations between the two embodiments will be discussed. The power supply 64 is mounted lower on the main frame 54 and at an opposed end, adjacent to the pallet lift 96. The tote sack dispensing assembly 112 is mounted over the hatch opening 78. The transfer hose connection 62 extends from an opposed end of the main frame 54 as compared to the mixing platform 22 of FIGS. 6 and 7. The main frame 54 extends out beyond the pallet lift 96 (above the power supply 64), providing an additional deck 108 where additional ingredients (e.g., bags of chemicals) may be stored. The operation of the mixing platform 22 of FIG. 11 is essentially the same as that for FIGS. 6 and 7 and so will not be discussed further herein.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A tracked vehicle and system for spraying comprising:
a tank configured to hold a slurry;
tracks configured to propel the tracked vehicle;
at least one spray nozzle configured to direct the slurry therethrough;
a spray pump system configured to selectively draw the slurry from the tank and direct the slurry through the at least one spray nozzle; and
an engine that provides power to both the tracks to propel the tracked vehicle and to the spray pump system to selectively draw the slurry from the tank and direct the slurry through the at least one spray nozzle.

2. The tracked vehicle and system of claim 1 further comprising a cab configured to be occupied by a vehicle operator and allow the vehicle operator to control propelling of the tracked vehicle and spraying of the slurry from withing the cab.

3. The tracked vehicle and system of claim 2 wherein the at least one nozzle is a front spray assembly that is pivotable and wherein the cab is configured to allow the vehicle operator to control the pivoting of the front spray nozzle and when the slurry is discharged from the front spray assembly from within the cab.

4. The tracked vehicle and system of claim 3 wherein the at least one nozzle is also a nozzle system mounted adjacent to a rear of the tracked vehicle, with the nozzle system including a plurality of spray nozzles, and wherein the cab is configured to allow the vehicle operator to control when each of the plurality of spray nozzles discharges the slurry from within the cab.

5. The tracked vehicle and system of claim 2 wherein the at least one nozzle is a nozzle system mounted adjacent to a rear of the tracked vehicle, with the nozzle system including a plurality of spray nozzles, and wherein the cab is configured to allow the vehicle operator to control when each of the plurality of spray nozzles discharges the slurry from within the cab.

6. The tracked vehicle and system of claim 1 wherein the at least one nozzle is a front spray assembly that is pivotable and wherein the spray pump system has a variable speed that can be adjusted to account for at least one of a viscosity of the slurry, an amount of slurry to be applied and a distance that the slurry is sprayed.

7. The tracked vehicle and system of claim 6 wherein the at least one nozzle is also a nozzle system mounted adjacent to a rear of the tracked vehicle, with the nozzle system including a plurality of spray nozzles, and wherein the variable speed of the spray pump system can be adjusted to account for at least one of a viscosity of the slurry, an amount of slurry to be applied and a how many of the plurality of spray nozzles are being employed for spraying the slurry.

8. The tracked vehicle and system of claim 1 wherein the at least one nozzle is a nozzle system mounted adjacent to a rear of the tracked vehicle, with the nozzle system including a plurality of spray nozzles, and wherein the variable speed of the spray pump system can be adjusted to account for at least one of a viscosity of the slurry, an amount of slurry to be applied and a how many of the plurality of spray nozzles are being employed for spraying the slurry.

9. The tracked vehicle and system of claim 1 including a transfer system operatively engaging the spray pump system to selectively cause slurry to be drawn from the hose into the tank.

10. The tracked vehicle and system of claim 9 wherein the transfer system comprises a transfer hose operatively engaging the spray pump system to selectively cause slurry to be drawn from the hose into the tank.

11. The tracked vehicle and system of claim 9 further comprising:
a mixing platform comprising:
a main frame including decks configured to support a mixing platform operator;
a blending tank mounted on the main frame and including an auger mounted for selective rotation within the blending tank;
a tank outlet and transfer connection configured to receive the slurry from the blending tank and direct the slurry into the transfer system.

12. The tracked vehicle and system of claim 11 wherein the mixing platform further comprises a mulch grinder assembly configured to grind a material and direct the material into the blending tank.

13. The tracked vehicle and system of claim 12 wherein the mixing platform further comprises a hatch opening and bag cutter operatively engaging the blending tank and configured to allow one or more ingredients of the slurry to pass through the hatch opening into the blending tank, with the hatch opening adjacent to a portion of the decks.

14. The tracked vehicle and system of claim 13 wherein the mixing platform further comprises a chemical dispensing tank positioned above and configured to selectively allow the one or more of the ingredients to enter the blending tank.

15. The tracked vehicle and system of claim 13 wherein the mixing platform further comprises a tote sack dispenser assembly configured to selectively release the one or more of the ingredients into the blending tank.

16. The tracked vehicle and system of claim 13 wherein the mixing platform further comprises a chemical dispensing tank positioned above and configured to selectively allow the one or more of the ingredients to enter the blending tank.

17. The tracked vehicle and system of claim 11 wherein the mixing platform further comprises wherein the mixing platform further comprises a hatch opening and bag cutter operatively engaging the blending tank and configured to allow an ingredient of the slurry to pass through the hatch opening into the blending tank, with the hatch opening adjacent to a portion of the decks.

18. The tracked vehicle and system of claim 11 wherein the mixing platform further comprises a pallet lift located adjacent to a portion of the decks, a drive assembly, and a lift platform configured to be raised and lowered by the drive assembly to lift at least one ingredient of the slurry to a height of the portion of the decks adjacent to the pallet lift.

19. The tracked vehicle and system of claim 11 wherein the mixing platform further comprises a power supply operatively engaging the auger to selectively cause the auger to rotate.

20. The tracked vehicle and system of claim 19 wherein the mixing platform further comprises a mulch grinder assembly configured to grind a material and direct the material into the blending tank, and wherein the power supply operatively engages the mulch grinder to selectively actuate the mulch grinder.
